(19) United States
(12) Patent Application Publication
(10) Pub. No.: US 2007/0047093 A1
(43) Pub. Date: Mar. 1, 2007

(54) METHOD AND DEVICE FOR THE IMMERSION AND CLEANING OF THE FRONT LENS OF MICROSCOPE OBJECTIVES

(75) Inventors: Lutz Hoering, Aalen (DE); Andreas Nolte, Rosdorf (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Carl Zeiss MicroImaging GmbH

(21) Appl. No.: 11/467,231

(22) Filed: Aug. 25, 2006

(30) Foreign Application Priority Data
Aug. 25, 2005 (DE) 10 2005 040 828.1

(51) Int. Cl. G02B 21/02

(52) U.S. Cl. 359/661

(57) ABSTRACT

A method and a device are provided for the immersion and for the cleaning of the front lens of microscope objectives in fully automatic microscope systems, in particular inverted microscopes, for the examination of biological and/or chemical samples by which, besides an automatic immersion process, an automatic cleaning of the front lens of the microscope objective is achieved at the same time at the conclusion of the immersion process. In a method in which water is preferably used as immersion liquid, the immersion liquid is provided at the same time as a cleaning liquid for the automatic cleaning of a front lens of a microscope objective at the conclusion of the immersion process. The device according to the invention for implementing the method comprises a receiving vessel which can be placed on the front lens of the microscope objective. Openings are provided in the receiving vessel and are connected to a tube system for supplying fresh immersion and cleaning liquid from a reservoir vessel and for discharging the soiled liquid into a receiving vessel.

### CROSS-REFERENCE TO RELATED APPLICATION

This application claims priority of German Application No. 10 2005 040 828.1, filed Aug. 25, 2005, the complete disclosure of which is hereby incorporated by reference.

### BACKGROUND OF THE INVENTION

a) Field of the Invention

The invention is directed to a method and a device for the automatic immersion and for the automatic cleaning of the front lens of microscope objectives in automatic microscope systems, in particular inverted microscopes, for the examination of biological and/or chemical samples.

b) Description of the Related Art

In microscopy, immersion is generally carried out in microscope objectives in order to increase the numerical aperture and, therefore, the optical resolution of microscope objectives by introducing a transparent liquid, such as water or oil, into an intermediate space between a sample and the microscope objective. In cellular biology, water immersion objectives, among others, are used to observe biological samples. Particularly when using immersion objectives in automatic microscope systems in which processes are controlled automatically by a control computer, manual operation during the microscopic examinations is no longer provided. For this reason, for the use of immersion objectives in automatic microscope systems, the immersion process and the cleaning of the front lens of the microscope objective must be carried out automatically at the conclusion of the immersion process.

DE 101 23 027 A1 discloses a device and a method for examination of chemical and/or biological samples, particularly by means of a confocal microscope having a feed device for automatically supplying an immersion medium, water or oil. The feed device has a feed tube that is rigidly connected to the objective, and the immersion medium is supplied from a reservoir vessel to a gap between the sample carrier and the exit lens of the objective by means of a controllable pump. Prior to supplying the immersion medium, a cleaning fluid is supplied to the gap for cleaning the outside lens and the sample carrier. A collection gutter connected to the objective head is provided for carrying away the immersion medium.

U.S. Pat. No. 3,202,049 discloses a device which can be fastened to a special microscope objective and which has an enclosed and therefore limited liquid reservoir without means for supplying and removing an oil immersion medium. A loss of liquid occurs during operation due to exiting oil, and liquid that has been used once is forfeited.

Further, DE 202 05 080 U1 discloses an immersion objective for microscopic examination of an object provided with a shield element which can substantially enclose the intermediate space between the immersion objective and the object and can be filled with immersion liquid in order to prevent a deterioration of imaging characteristics and particularly of resolution due to fluctuating optical characteristics of the immersion liquid.

### OBJECT AND SUMMARY OF THE INVENTION

It is the primary object of the invention to provide a method and a device for the use of immersion objectives in automatic microscope systems, particularly in inverted microscopes, by means of which, besides an automatic immersion process, an automatic cleaning of the front lens of the microscope objective is achieved at the conclusion of the immersion process.

This object is met by a method for the automatic immersion and for the automatic cleaning of the front lens of a microscope objective, preferably with water as immersion liquid, which is provided at the same time for the automatic cleaning of the front lens of the microscope objective at the conclusion of the immersion process. A device according to the invention for implementing the above method comprises a receiving vessel which is shaped cylindrically in particular and which can be placed on the front lens of a microscope objective. Openings are provided in the receiving vessel and are connected to a tube system for supplying and removing the immersion and cleaning liquid, and the liquid that is removed is collected in a receiving vessel.

The immersion liquid, which forms as a liquid column after being introduced into a gap between a front lens of the microscope objective and an object carrier and which adheres due to occurring adhesion forces as the object carrier is approached, must completely withdraw from the object carrier at the conclusion of the immersion process so as to be used simultaneously for cleaning the front lens of the microscope objective and to prevent contamination of the object carrier and of the front lens of the microscope objective. Cleaning of the front lens of the microscope objective is absolutely necessary in the operation of an inverted automatic microscope because substantial contamination can occur from particles falling down while working at the microscope. Therefore, water, not lubricating oils, is used as immersion liquid in the proposed method because water possesses good solvent properties for loosening other liquids and solids as well. Mixtures of water and organic and/or inorganic solvents are also advantageous for adapting the refractive index of the immersion liquid by means of a composition of this kind for removing contaminants. Soiling occurring during an immersion process may cause contamination of the immersion liquid, which leads to a deterioration of the optical characteristics of the microscope. In addition, the openings through which the immersion liquid flows in and out can become clogged.

An important precondition for carrying out the method is that the diameter of the liquid column on the object carrier corresponds at least to the field of view of the microscope objective that is used because otherwise imaging errors would occur. The larger the opening of the front lens of the microscope objective, the larger the liquid column that must be formed. The height of the liquid column is determined by the working distance of the microscope objective.

It is advantageously provided that a fixed liquid volume is adjusted for forming the liquid meniscus before the start of the immersion process and after every interruption between the liquid column and the object carrier so that the front lens is cleaned when removing the immersion and cleaning liquid.

The device for implementing the method preferably comprises a receiving vessel which is formed cylindrically in particular and which can be placed on a front lens of a microscope objective. An immersion and cleaning liquid is supplied to and removed from the cylindrical receiving vessel via openings which are provided in the bottom of the receiving vessel and are connected to a tube system. The cylindrical receiving vessel is adapted to the corresponding front lenses of the microscope objectives so as to be tightly held on the latter. At least one opening is provided for the entrance of the immersion and cleaning liquid, and at least one opening is provided for the exit of the immersion and cleaning liquid. The openings in the bottom of the receiving vessel are advantageously constructed as bore holes.

The supply of fresh immersion and cleaning liquid is carried out by means of a reservoir vessel which is either fastened to a microscope stand above the microscope objective and opened and closed by a valve, or the reservoir vessel is fastened to the microscope stand below the microscope objective and the immersion and cleaning liquid is pumped into the cylindrical receiving vessel by a pump.

The soiled immersion and cleaning liquid that is removed is collected in a receiving vessel. Either the immersion and cleaning liquid flows into the receiving vessel by gravitational force and the flow of liquid is regulated by a valve, or the immersion and cleaning liquid is pumped into the receiving vessel by a pump. The receiving vessel and the reservoir vessel are preferably made of plastic.

The invention will be described more fully in the following with reference to an embodiment example that is shown schematically in the drawings.

### BRIEF DESCRIPTION OF THE DRAWINGS

In the drawings:

FIG. 1 shows a general view of an inverted microscope with device elements;

FIG. 2 shows a device according to the invention for the immersion and cleaning of front lenses of microscope objectives in the immersion mode; and

FIG. 3 shows a device according to the invention for the immersion and cleaning of front lenses of microscope objectives in the front lens cleaning mode.

### DESCRIPTION OF THE PREFERRED EMBODIMENT

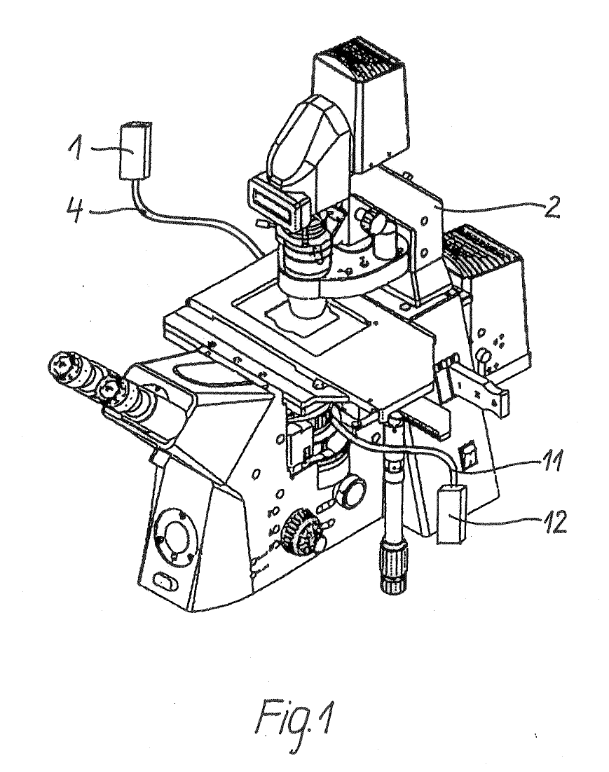

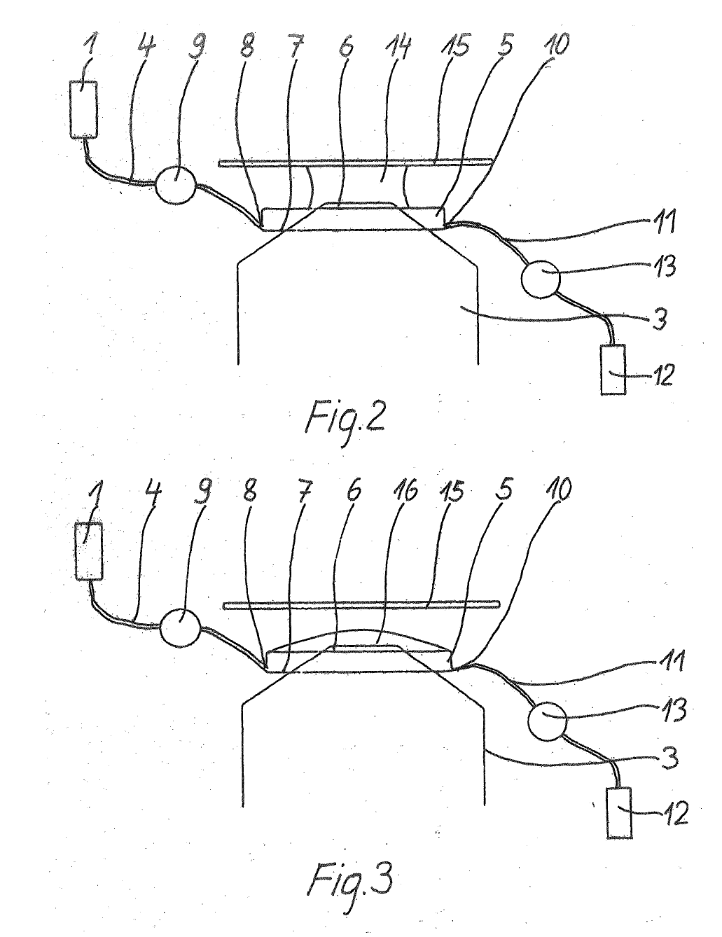

FIG. 1 shows an inverted microscope with elements of the device for the immersion and cleaning of a front lens 6 of a microscope objective 3. The fresh immersion and cleaning liquid is located in a reservoir vessel 1 which is arranged above the microscope objective 3 at a microscope stand 2 so that the immersion and cleaning liquid is conducted into a cylindrical receiving vessel 5 according to FIGS. 2 and 3 by gravitational force via a tube system 4. The receiving vessel 5 can be placed on the front lens 6 of the microscope objective 3. At least one opening 8 to which the tube system 4 is connected for supplying the fresh immersion and cleaning liquid is provided in a bottom 7 of the receiving vessel 5 shown in FIGS. 2 and 3. The cylindrical receiving vessel 5 is adapted to the corresponding front lenses 6 of different microscope objectives 3 and is tightly held on them. The influx of immersion and cleaning liquid is regulated by a valve 9. At least one opening 10 is provided in the cylindrical receiving vessel 5 for removal of the immersion and cleaning liquid, the soiled immersion and cleaning liquid being conducted through this opening 10 into a receiving vessel 12 by a connected tube system 11. The immersion and cleaning liquid flows into this receiving vessel 12 by gravitational force. The receiving vessel 12 is opened and closed by a valve 13. The immersion liquid, which forms as a liquid column 14 corresponding to FIG. 2 after being guided into a gap between the front lens 6 of the microscope objective 3 and an object carrier 15 and which adheres as the object carrier 15 is approached due to the occurring adhesion forces, must be completely withdrawn from the object carrier 15 at the conclusion of the immersion process and serves at the same time to clean the front lens 6 of the microscope objective 3 so as to prevent soiling of the object carrier 15 and of the front lens 6 of the microscope objective 3.

The cleaning of the front lens 6 of the microscope objective 3 is absolutely necessary for the operation of an inverted automatic microscope because particles falling down while working at the microscope can lead to substantial contamination.

FIG. 3 shows the device for the immersion and cleaning of the front lens 6 of the microscope objective 3 in the operating mode for cleaning the front lens. After the immersion liquid withdraws from the object carrier 15, the front lens 6 is cleaned as the immersion liquid flows off.

It must be ensured that the diameter of the liquid column 14 in relation to the object carrier corresponds at least to the field of view of the microscope objective 3 that is used because, otherwise, imaging errors can occur. The larger the opening of the front lens 6 of the microscope objective 3, the larger the diameter of the liquid column 14 that must be formed. The height of the liquid column 14 is determined by the working distance of the microscope objective 3.

Therefore, water, not lubricating oils, is used as immersion liquid in the method according to the invention because water possesses good solvent properties for loosening other liquids and solids as well. Mixtures of water and organic/inorganic solvents are also considered advantageous so that the refractive index of the immersion liquid can be adapted by means of a composition of this kind for removing contaminants. A fixed liquid volume is adjusted for forming the liquid meniscus 16 before the start of every immersion process and after every interruption between the liquid column 14 and the object carrier 15.

In a variant embodiment example, not shown, the reservoir vessel 1 is fastened to the microscope stand 2 below the microscope objective 3, and the immersion and cleaning liquid is then pumped into the cylindrical receiving vessel 5 by a pump. The immersion and cleaning liquid to be removed is likewise pumped into the receiving vessel 12 by a pump.

The invention is not limited to the embodiment examples but, rather, can be varied in many ways within the framework of the disclosure with respect to the arrangement of the reservoir vessel and collecting vessel and the construction of the receiving vessel.

While the foregoing description and drawings represent the present invention, it will be obvious to those skilled in the art that various changes may be made therein without departing from the true spirit and scope of the present invention.

### REFERENCE NUMBERS

1 reservoir vessel for fresh immersion and cleaning liquid
2 microscope stand
3 microscope objective
4 tube system for influx
5 cylindrical receiving vessel
6 front lens
7 bottom of the cylindrical receiving vessel
8 opening for influx
9 valve for shutting off influx
10 opening for discharge
11 tube system for discharge
12 receiving vessel for contaminated immersion and cleaning liquid
13 valve for receiving vessel
14 liquid column
15 object carrier
16 liquid meniscus

What is claimed is:

1. A method for the automatic immersion and/or for the automatic cleaning of the front lens of microscope objectives in automatic microscope systems for the examination of biological and/or chemical samples, wherein immersion and/or cleaning liquid is supplied to and removed from a gap which is formed between a front lens of a microscope objective and an object carrier, comprising the steps of:
introducing immersion and/or cleaning liquid from a reservoir vessel into the gap between the front lens of the microscope objective and an object carrier by a receiving vessel which can be arranged on a front lens of a microscope objective until the immersion and cleaning liquid covers the front lens;
subsequently, as the microscope objective approaches the object carrier, the liquid film on the front lens forming as a liquid column between the microscope objective and the object carrier due to the occurring adhesion forces;
at the conclusion of the immersion process, drawing the microscope objective back until the liquid column completely withdraws from the object carrier; and
the immersion and cleaning liquid serving to clean the front lens of the microscope objective while being removed from the receiving vessel.

2. The method according to claim 1, wherein the immersion and/or cleaning liquid is water.

3. The method according to claim 1, wherein the immersion and/or cleaning liquid is a mixture of water and organic and/or inorganic solvents.

4. The method according to claim 1, wherein the diameter of the liquid column corresponds at least to the field of view of the microscope objective that is used.

5. The method according to claim 1, wherein the height of the liquid column is determined by the working distance of the microscope objective.

6. The method according to claim 1, wherein the diameter of the liquid column to be formed must be increased as the opening of the front lens of the microscope objective increases.

7. The method according to claim 1, wherein a fixed liquid volume is adjusted for forming the liquid meniscus before the start of the immersion process and after every interruption between the liquid column and the object carrier.

8. A device for implementing the method according to claim 1, said device comprising:
a receiving vessel which is formed cylindrically in particular and which can be placed on the front lens of the microscope objective;
at least one opening connected to a tube system being provided in a bottom of the cylindrical receiving vessel for supplying the immersion and cleaning liquid from a reservoir vessel to the cylindrical receiving vessel; and
soiled immersion and cleaning liquid flowing into a receiving vessel at the conclusion of the immersion and cleaning of the front lens of the microscope objective via at least one opening which is provided in the bottom of the cylindrical receiving vessel and which is connected to a tube system.

9. The device according to claim 8, wherein the shape and size of the cylindrical receiving vessel is adapted to the different front lenses of microscope objectives and is tightly held at the latter.

10. The device according to claim 8, wherein the reservoir vessel and the receiving vessel are arranged in particular at a microscope stand.

11. The device according to claim 8, wherein the reservoir vessel is fastened above the microscope objective to the microscope stand for the influx of the immersion and cleaning liquid, and the influx into the receiving vessel can be regulated by means of a valve.

12. The device according to claim 8, wherein the reservoir vessel is fastened below the microscope objective to the microscope stand for the influx of the immersion and cleaning liquid, and the influx into the receiving vessel is provided by means of a pump.

13. The device according to claim 8, wherein the receiving vessel for receiving the soiled immersion and cleaning liquid is arranged at the microscope stand below the microscope objective, and the flow of immersion and cleaning fluid out of the receiving vessel is provided by a valve or a pump.

14. The device according to claim 8, wherein the reservoir vessel for the fresh immersion and cleaning liquid and the receiving vessel for the soiled immersion and cleaning liquid are made of plastic.
